(19) United States
(12) Patent Application Publication
(10) Pub. No.: US 2025/0073622 A1
(43) Pub. Date: Mar. 6, 2025

(54) DEVICE FOR FILTERING A LIQUID PLASTIC AND CORRESPONDING OPERATING METHOD

(71) Applicant: NORDSON CORPORATION, WESTLAKE, OH (US)

(72) Inventor: Robert MIDDLER, Havixbeck (DE)

(73) Assignee: NORDSON CORPORATION, WESTLAKE, OH (US)

(21) Appl. No.: 18/727,454

(22) PCT Filed: Jan. 17, 2023
(86) PCT No.: PCT/IB2023/050401

§ 371 Date: Jul. 9, 2024

(30) Foreign Application Priority Data
Jan. 17, 2022 (DE) 20 2022 100 235.5

(51) Int. Cl. B01D 29/68; B01D 29/05; B01D 29/52

(52) U.S. Cl. CPC B01D 29/68; B01D 29/05; B01D 29/52; B01D 2201/202

(57) ABSTRACT

The invention relates to a device (2) for filtering a liquid plastic, with a housing (4) with an inlet (6) for introducing the plastic and an outlet (8) for discharging the plastic, a screen carrier (12) accommodated in the housing (4) and having a screen chamber (10) for accommodating a filter element (14), a filter element (14) arranged in the screen chamber (10) of the screen carrier (12) and having a filter side (16) and a clean side (18), the filter element (14) being connectable to the inlet (6) and the outlet (8) in such a way that the plastic passes through and is filtered by the filter element (14) in a filtering flow direction (56) from the filter side (16) to the clean side (18) and wherein the filter element (14) can be cleaned by backwashing by plastic flowing counter to the filtering flow direction (56), a backwashing feed channel (20) fluidly connected to the clean side (18) of the filter element (14), which feed channel (20) is set up for this purpose, the filter element (14) against the direction of filtration flow (56), and a backwash discharge channel (22) which is fluid conductively connected to the filter side (16) of the filter element (14) and which is arranged to discharge the backwashed plastic after it has passed the filter element (14). According to the invention, a backwash screen support (24) fluidly connected to the backwash discharge channel (22) is proposed, comprising a screen chamber (26) for receiving a backwash filter element (28) and a backwash filter element (28) arranged in the screen chamber (26) and adapted to filter the backwashed plastic.

### CROSS-REFERENCE TO RELATED APPLICATION

This application is a National Stage Application of International Patent App. No. PCT/IB2023/050401, filed Jan. 17, 2023, which claims the benefit of German Application No. 202022100235.5, filed Jan. 17, 2022, the entire disclosures of both of which are hereby incorporated by reference as if set forth in their entirety herein.

### FIELD OF THE DISCLOSURE

The disclosure relates to a device for filtering a liquid plastic, comprising a housing having an inlet for introducing the plastic and an outlet for discharging the plastic, a screen carrier accommodated in the housing and having a screen chamber for accommodating a filter element, a filter element arranged in the screen space of the screen carrier and having a filter side and a clean side, the filter element being connectable to the inlet and the outlet in such a way that the plastic passes the filter element in a filtering flow direction from the filter side to the clean side and is filtered, and wherein the filter element is cleanable by backwashing by plastic flowing against the direction of filtration flow, a backwash supply channel fluidly connected to the clean side of the filter element and adapted to supply plastic to the filter element against the direction of filtration flow, and a backwash discharge channel fluidly connected to the filter side of the filter element and adapted to discharge the backwashed plastic after it has passed the filter element.

### BACKGROUND OF THE DISCLOSURE

Such filtration devices are known from the prior art. They are used to filter liquefied plastic, also known as molten plastic, in industrial production processes. The filter elements used for filtration pick up contaminants from the molten plastic and must therefore be cleaned at regular intervals. For this purpose, it is known to feed liquid plastic to the filter elements against the direction of filtration flow in order to detach and remove contaminants from the filter element. This process is also known as backflushing. The plastic used for backflushing absorbs the contaminant particles picked up on the filter side and is then discharged from the housing and disposed of.

Although such devices have proven themselves in practice, there is still room for improvement. A particular disadvantage is that the plastic melt used for backflushing is lost during each backflushing process and is no longer available for the production process. Considered over a longer operating period, this results in significant loss costs and large quantities of contaminated plastic melt to be disposed of. Against this background, the disclosure was based on the task of further developing a filtration device of the type described at the beginning and a process in such a way that the disadvantages found in the prior art are eliminated as far as possible. In particular, a filtration device was to be specified in which less plastic melt is lost through backflushing processes.

### SUMMARY OF THE DISCLOSURE

According to the disclosure, the task is solved in a filtering device of the type mentioned above by a backflush screen carrier connected in a fluid-conducting manner to the backflush discharge channel and having a screen chamber for receiving a backflush filter element and by a backflush filter element arranged in the screen chamber and adapted to filter the backflushed plastic.

The disclosure makes use of the knowledge that by filtering the backflushed plastic again, it can be achieved that a large part of the backflushed plastic can be returned to the process in purified form. Only a small portion of the backflushed plastic, also referred to as rinsing mass, which now has a high concentration of dirt particles, has to be discharged from the device and disposed of. This allows the amount of plastic lost as a result of backwashing to be significantly reduced, for example from about one liter per backwashing operation for an exemplary device to about 0.15 liter per backwashing operation.

This makes the operation of the filtration device more economical for the operator, which applies in particular to more highly contaminated plastic melt, because the large number of backflushes required here means that the plastic melt lost through the backflushing processes becomes more and more important. Overall, backflush losses are thus reduced. The amount of plastic to be disposed of is reduced, which is also ecologically beneficial.

According to a preferred embodiment, the filtration device has a second backflush discharge channel conductively connected to the backflush filter element and the outlet fluid, which is set up to feed the plastic filtered by the backflush screen support to the outlet. In this way, it is achieved that the plastic used for backflushing the filter element and filtered by the backflushing screen support can be fed to the process. This reduces the amount of plastic rejected and a large part of the plastic used for backflushing is returned to the productive process.

Preferably, according to an alternative preferred embodiment, the filtration device comprises a pressure generation unit which is fluidly connected to the backwash feed channel and/or the second backwash discharge channel, the pressure generation unit being arranged to press plastic for backwashing through the screen support and/or the backwash screen support against the direction of flow. The pressure generating unit makes use of the knowledge that by applying an additional pressure to the plastic used for backwashing, a more efficient backwashing process can be achieved. For example, in particular, the abrupt application of a pressure pulse to the plastic used for backwashing can achieve better detachment of contaminants from the backwashed filter elements. In addition, the pressure generation unit facilitates the subsequent reintroduction of the filtered backwashed plastic into the process. The additional pressure applied by the pressure generation unit ensures that the overall system pressure remains constant and that the plastic melt used for backflushing can be reintroduced into the process along the pressure gradient.

Preferably, the pressure generation unit is connected to the discharge channel in a fluid conducting manner and is set up to remove plastic from the discharge channel and make it available for backflushing. In other words, the pressure generation unit feeds itself from the discharge channel, takes plastic melt from it and makes the removed plastic melt available for backflushing at a pressure that is regularly higher than the system pressure.

The plastic used for backflushing is thus removed within the filtration device; an external feed is not required.

According to a preferred embodiment, the pressure generating unit has one of the following elements or is designed as one of the following: Piston, in particular displacement plunger, gear pump. It has been shown that in particular the use of a piston in the form of a displacement plunger is particularly suitable for providing pressurized plastic for backflushing.

According to a preferred embodiment, the housing has a feed channel fluidly connected to the inlet for feeding plastic to the filter side of the filter element and a discharge channel fluidly connected to the outlet for discharging the filtered liquefied plastic from the clean side of the filter element. The channels described here serve to supply melt to be filtered to the filter side of the filter element and to subsequently discharge the filtered melt from the clean side of the filter element.

According to an alternative embodiment, the screen chamber of the screen carrier and/or the backflush screen carrier is a first screen chamber, wherein the screen carrier comprises a second screen chamber, and wherein a second filter element is arranged in the second screen chamber. The use of several screen compartments and screens in a screen carrier or backflush screen carrier has proven to be advantageous in order to ensure continuous filtration operation of the device. For example, as will be described in more detail in the context of the figure description, such a configuration allows one of the filter elements to be used for normal filtration operation while the second filter element is backwashed.

The disclosure is further embodied in that the filtration device comprises a second feed channel fluidly connected to the inlet for feeding plastic to a filter side of the second filter element, and a second discharge channel fluidly connected to the outlet for discharging the filtered plastic from the clean side of the second filter element, wherein the second filter element is connectable to the second discharge channel such that the plastic passes the second filter element in the filtering flow direction from the filtering side to the clean side and is filtered. Preferably, the filtration device further comprises a second backwash supply channel fluidly connected to the filter side of the second filter element, which is adapted to supply backwash fluid to the second filter element against the filtration flow direction, and a second backwash discharge channel fluidly connected to the clean side of the second filter element, which is arranged to discharge the backwash fluid after it has passed through the second filter element, the second backwash discharge channel being connected in a fluid-conducting manner to the first or the second backwash filter element of the backwash screen support. The embodiment example is based on the principle that the second filter element as well as the second backwash filter element has the same configuration of feed and discharge channels, so that also for the second filter element the plastic used for backwashing this filter element is filtered and cleaned by means of the second backwash filter element in such a way that a major part of the plastic melt used for rinsing the second filter element can be fed to the process after cleaning by means of the second backwash filter element. The configuration as a whole makes it possible to use at least one filter element per screen support for continuous filter operation while another is being backflushed.

According to a preferred embodiment, the screen carrier is a first screen carrier, wherein the filtering device comprises a second screen carrier, wherein the second screen carrier is formed analogously to the first screen carrier. This preferred embodiment also takes into account the idea that in particular three filter elements are available for the filtration process, so that the filtration device allows permanent filtration operation even if one of the filter elements is backwashed.

Preferably, the filter element of the screen support has essentially the same pore size as the filter element of the backflush screen support. This ensures that the plastic melt processed by means of the backflush screen support has the same degree of purity as the plastic melt filtered by means of the filter element.

According to an alternative embodiment, the filtration device has a storage device which is connected in a fluid-conducting manner to the backflush discharge channel and/or the second discharge channel and is set up to store backflush fluid from the backflush discharge channel and/or the second backflush discharge channel and then to discharge it again.

Preferably, the accumulator device has a piston, in particular an accumulator plunger. The use of a piston in the form of an accumulator plunger has proved particularly useful for forming the accumulator device.

The disclosure has been described above with reference to a filtration device. In a further aspect, the disclosure relates to a method for operating a filtering device, in particular a filtering device according to one of the above embodiments. The disclosure solves the task described at the beginning with respect to the method, in which the latter comprises the steps of: Providing a filtering device with a screen carrier, the screen carrier having at least one filter element arranged in a screen chamber, filtering the liquefied plastic by means of the filter element in a filtering flow direction, backflushing the filter element by means of the filtered plastic counter to the filtering flow direction, passing the backflushed plastic after passing the filter element to a backflush filter element, filtering the backflushed plastic by means of the backflush filter element.

The method makes use of the same advantages and preferred embodiments as the filtration device according to the disclosure. In this regard, reference is made to the above explanations and their contents are included herein. In summary, the method also takes advantage of the finding that a major portion of the molten plastic used for backflushing is treated by filtering by means of the backflushing filter element and returned to the process. The amount of highly contaminated plastic to be discharged from the housing is significantly reduced. This makes the operation of the filtration device more economical for the operator, which is particularly true for higher-contaminated plastic melt, because the large number of backflushes required here means that the plastic melt lost through the backflush processes becomes increasingly important. Overall, backflushing losses are thus reduced.

The process is further formed by the step of: Combining the filtered backflushed plastic and the filtered liquefied plastic. In other words, it is proposed to feed the filtered backflushed plastic to the regular process comprising the filtered liquefied plastic.

According to a preferred embodiment, the method is further formed by the steps: Backflushing the backflush filter element by means of the filtered liquefied plastic, discharging the contaminated liquefied plastic after the backflushing of the backflush filter element. This has the advantage that only a smaller quantity of a highly contaminated liquefied plastic has to be discharged from the housing after the backflushing of the backflushing filter element. This quantity of highly contaminated plastic to be discharged is significantly lower than in processes known from the prior art.

The method is further illustrated in that the filtering of the liquefied plastic is performed both by means of the filter element and by means of the backflush filter element. In this way it is ensured that also the backflush filter element, when it is not used for filtering backflush plastic, is permanently flowed through, so that the occurrence of clumping, or the like, is avoided.

The process is further formed in that the plastic used for backflushing the filter element or the backflushing filter element has a higher pressure for triggering the backflushing than the plastic to be filtered, the pressure difference being in particular 10 bar to 50 bar.

The overpressure of the plastic used for backflushing compared to the system pressure before backflushing can, on the one hand, ensure that contamination on the filter elements comes off more easily, especially when a pressure pulse is applied to the plastic used for backflushing. On the other hand, the overpressure enables an accelerated backflushing process and facilitates reintroduction into the process, so that no system pressure drop is associated with reintroducing the filtered plastic into the process.

According to a preferred embodiment, the plastic used for backflushing is sucked in in the backflushing direction downstream of the filter element and/or the backflushing filter element. In other words, in particular, already filtered plastic is used for the backwash process. This prevents the backwash filter element from becoming contaminated on the clean side.

### BRIEF DESCRIPTION OF THE DRAWINGS

Further features and advantages of the disclosure are apparent from the appended claims and the following description, in which examples of embodiments are explained in detail by means of schematic drawings.

In detail show:

FIG. 1 a schematic representation of a filtration device according to the disclosure;

FIGS. 2 and 3 are perspective views of an embodiment of a filtration device according to the disclosure in a production position;

FIGS. 4 and 5 the filtering device according to FIGS. 2 and 3 in a side view and a top view;

FIG. 6 the filtration device according to the disclosure in an operating state in which a filter element is backwashed;

FIG. 7 the filtration device according to the disclosure in an operating state in which a backwash filter element is backwashed;

FIGS. 8 to 18 exemplary sequence steps of a backwash sequence;

FIGS. 19 to 24 an alternative embodiment of a filtration device according to the disclosure comprising a suction device in different operating states.

### DETAILED DESCRIPTION

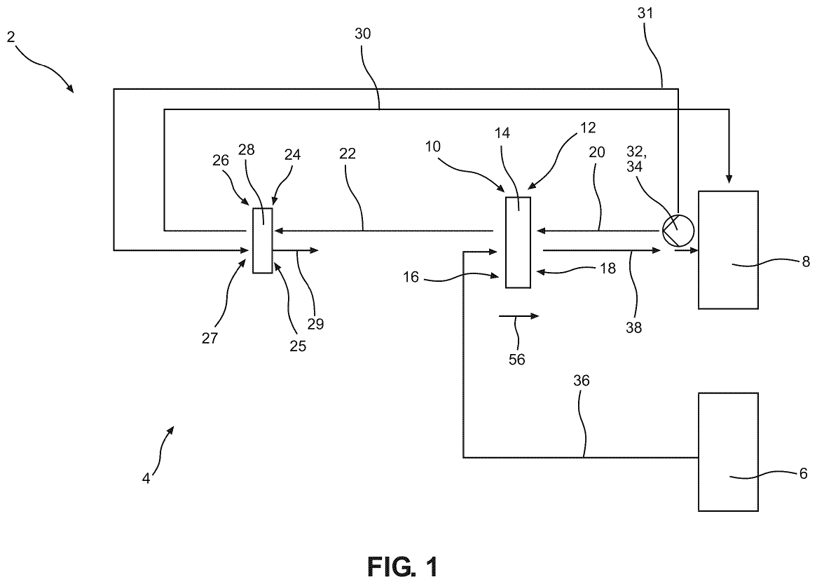

FIG. 1 shows a device 2 for filtering a liquid plastic in a schematic representation. The device 2 has a housing 4, not shown in more detail, with an inlet 6 for introducing the plastic and an outlet 8 for discharging the plastic. A screen carrier 12 is accommodated in the housing 4. The screen carrier 12 has a screen chamber 10 in which a filter element 14 is arranged. The filter element 14 has a filter side 16 and a clean side 18. The housing 4 further comprises a feed channel 36 fluidly connected to the inlet 6 for feeding plastic to the filter side of the filter element 14. The housing 4 further comprises a discharge channel 38 fluidly connected to the outlet 8 for discharging the filtered plastic from the clean side 18 of the filter element 14.

The device 2 further comprises a backwash feed channel 20 fluidly connected to the clean side 18 of the filter element 14, which is arranged to feed plastic to the filter element 14 against the filtration flow direction 56. The device 2 further comprises a backwash discharge channel 22 fluid-conductively connected to the filter side 16 of the filter element 14, which is arranged to discharge the backwashed plastic after it has passed the filter element 14. A backflush sieve carrier 24 is fluid-conductively connected to the backflush discharge channel 22. The backflush screen support 24 has a screen chamber 26 in which a backflush filter element 28 is arranged. The backflush filter element 28 is adapted to filter the backflushed plastic.

A second backwash supply channel 30 is disposed between the backwash filter element 28 and the outlet 8. The second backflush feed channel 30 is arranged to feed the plastic filtered by the backflush screen support 24 to the outlet 8.

The filtration device 2 further comprises a pressure generation unit 32. The pressure generating unit 32 is connected to the backwash supply channel 20. The filtration device 2 further comprises a second backwash discharge channel 31, which is connected to the pressure generation unit 32 and a clean side of the backwash filter element 28. A discharge outlet 29 is arranged on a filter side 25 of the backflush filter element 28, which serves to discharge highly contaminated melt. The pressure generating unit 32 is adapted to force plastic for backwashing through the screen support 12 and the backwash screen support 24 against the direction of filtration flow 56. In addition, the pressure generating unit 32 is adapted to force plastic for backwashing through the backwash filter element 28 via the second backwash discharge channel 31. The highly contaminated plastic is then discharged via the discharge outlet 29.

The pressure generation unit 32 is designed in particular as a displacement plunger 34. The pressure generation unit 32 is connected to the discharge channel 38 in a fluid-conducting manner. The pressure generation unit 32 is also set up to remove plastic from the discharge channel 38 and to make it available for backflushing.

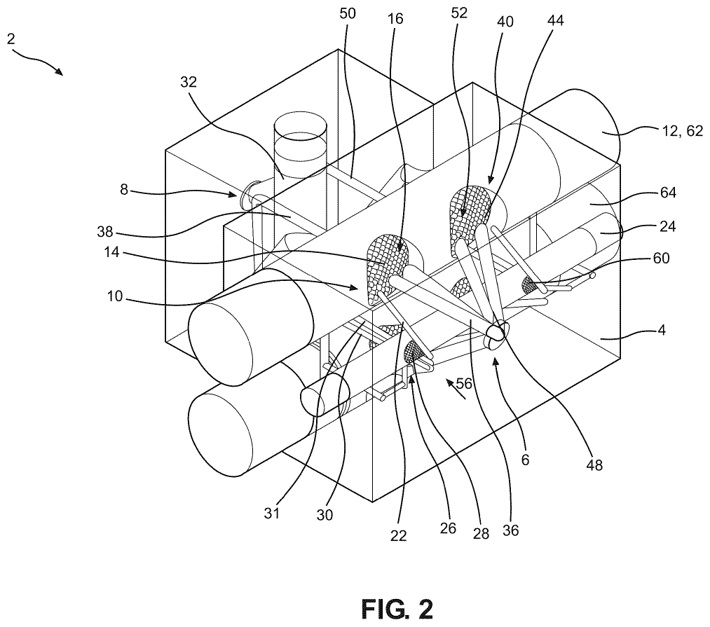

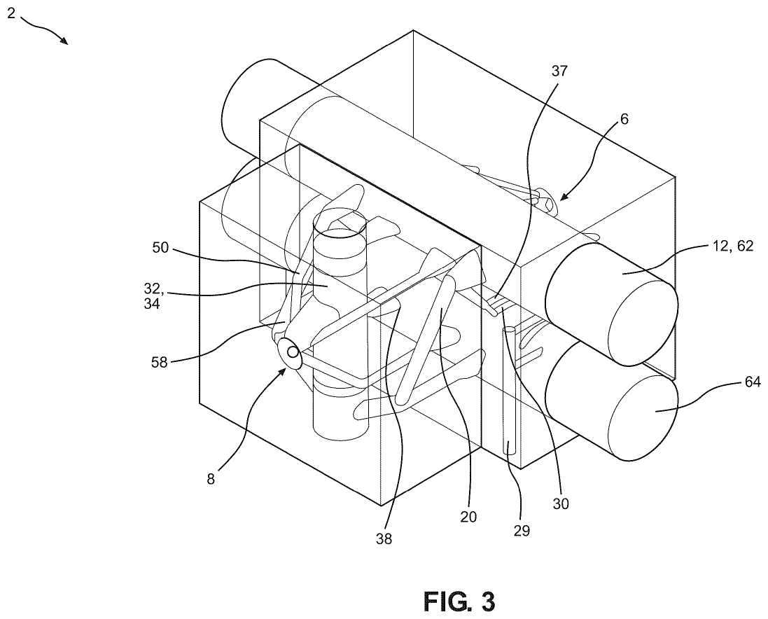

FIGS. 2 and 3 show a device 2 for filtering a liquid plastic in a perspective view. The device 2 has a housing 4 with an inlet for introducing the plastic and an outlet 8 for discharging the plastic. A screen carrier 12 is arranged in the housing 4, which in the present case is a first screen carrier 62. The screen carrier 12 has a screen chamber 10 in which a filter element 14 is accommodated. The filter element 14 has a filter side 16 and a clean side 18 not shown here. The filter element 14 is connectable to the inlet 6 and the outlet 8 such that the plastic of the filter element 14 passes and is filtered in a filtration flow direction 56 from the filter side 16 to the clean side 18. The device 2 further comprises a backwash supply channel 20, which is fluidly connected to the clean side 18 of the filter element 14 and is arranged to supply plastic to the filter element 14 against the filtration flow direction 56.

The device 2 further comprises a backwash discharge channel 22 fluidly connected to the filter side 16 of the filter element 14, which is arranged to discharge the backwashed plastic after passing the filter element 14. Further, the apparatus comprises a backflush screen support 24 fluidly connected to the backflush discharge channel 22 and having a screen chamber 26 and a backflush filter element 28 received thereon. A second backwash feed channel 30 is arranged between the backwash filter element 28 and the outlet 8, which is adapted to feed the plastic filtered by the backwash screen carrier 24 to the outlet 8. The filtering device 2 further comprises a pressure generating unit 32. The pressure generating unit 32 is fluidly connected to the backwash supply channel 20 and the second backwash discharge channel 31. The pressure generating unit 32 is adapted to force plastic for backwashing through the screen support 12 and the backwash screen support 24 against the direction of filtration flow 56.

The housing 4 further comprises a feed channel 36 fluidly connected to the inlet 6 for feeding plastic to the filter side 16 of the filter element 14. The housing 4 further comprises a discharge channel 38 fluidly connected to the outlet 8 for discharging the filtered liquefied plastic from the clean side 18 of the filter element 14. The pressure generating unit 32 is fluidly connected to the discharge channel 38 and is adapted to remove plastic from the discharge channel 38 and provide it for backwashing. The screen chambers 10, 26 of the screen carrier 12 and of the backwash screen carrier 24, respectively, are presently first screen chambers 10, 26, the screen carrier 12 having a second screen chamber 40 in which a second filter element 44 is arranged. The backwash screen support 24 comprises a second backwash filter element 46. The filtration device 2 comprises a second feed channel 48 fluidly connected to the inlet 6 for feeding plastic to a filter side 52 of the second filter element 44. The filtration device 2 further comprises a second discharge channel 50 fluidly connected to the outlet 8 for discharging the filtered plastic from the clean side 54 of the second filter element 44.

The second filtering element 44 is connectable to the second feed channel 36 and the second discharge channel 50 such that the plastic material passes the second filtering element 44 in the filtering flow direction 56 from the filtering side 52 to the clean side 54 and is filtered. The filtration device 2 further comprises a second backwash supply channel 58 of the second filter element 44 fluidly connected to the filter side 52 of the second filter element 44, which is arranged to supply backwash fluid to the second filter element 44 against the filtration flow direction 56. The filtration device 2 further comprises a second backwash discharge channel 60 fluidly connected to the filter side 52 of the second filter element 44, which is adapted to discharge the backwash fluid after passing the second filter element 44. The second backwash discharge channel 60 of the second filter element 44 is fluidly connectable to the second backwash filter element 46 of the backwash screen support 24. The filtration device further comprises a second screen support 64. The second screen carrier 64 is configured like the screen carrier 12 or the first screen carrier 62. Therefore, a detailed description is omitted.

In the state shown in FIGS. 2 and 3, the filtering device 2 is in a production position. In the production position, plastic melt is fed via the inlet 6, then fed to the filter elements 14, 44 and the lower filter elements by means of the feed channels 36, 48 and the feed channels not labeled below, filtered there, and then discharged in the direction of the outlet 8 via the discharge channels 38, 50 and the lower discharge channels. Furthermore, via the backflush discharge channels 22 and 58, unfiltered melt reaches the backflush filter elements 28, 46 is likewise filtered there and then discharged in the direction of the outlet 8 by means of the second backflush feed channels 30 and the second backflush feed channel of the second filter element (not shown) arranged correspondingly in mirror image. This applies in an analogous manner to the second screen support 64, although a detailed illustration is omitted.

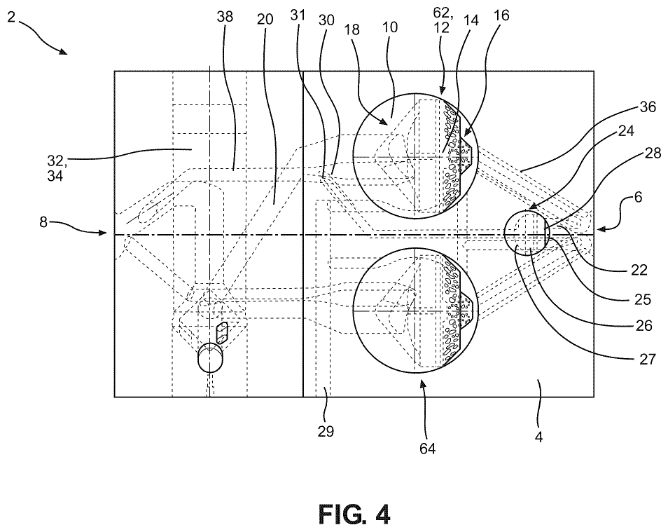

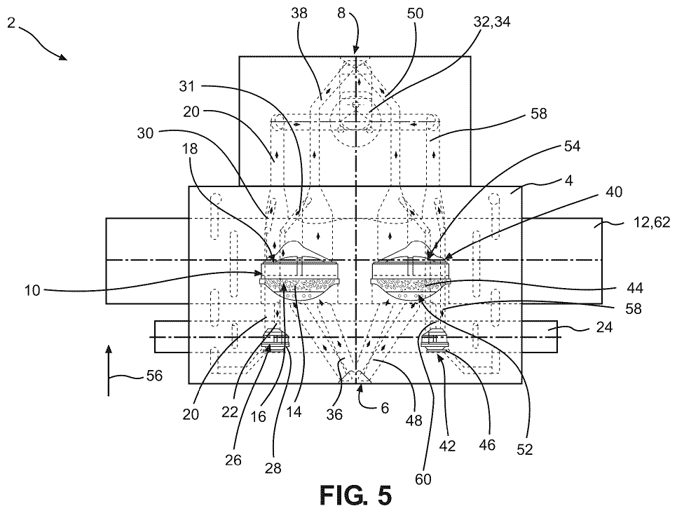

FIG. 4 shows a side view of the filtering device 2, wherein the sectional plane is perpendicular to a longitudinal axis of the screen carriers 12 or 62 and 64. FIG. 5 shows a top view, wherein here the sectional plane through the screen support 12 or 62 is perpendicular to a longitudinal axis of the displacement plunger 34.

The arrows drawn in FIG. 5 illustrate the flow of plastic from the inlet 6 to the outlet 8 via the filter elements 14, 44 and the backflush filter elements 28, 46. All six filter elements in total are used to filter the molten plastic. In detail, the melt passes from the inlet 6 via the feed channels 36, 48 to the filter elements 14, 44 and from there via the discharge channels 38, 50 to the outlet 8. An alternative plastic flow passes via the inlet 6 by means of the backflush discharge channel 22 and 60 to the backflush filter elements 28 and 46, respectively, is filtered there and then passes via the backflush feed channels 20, 58 to the outlet 8.

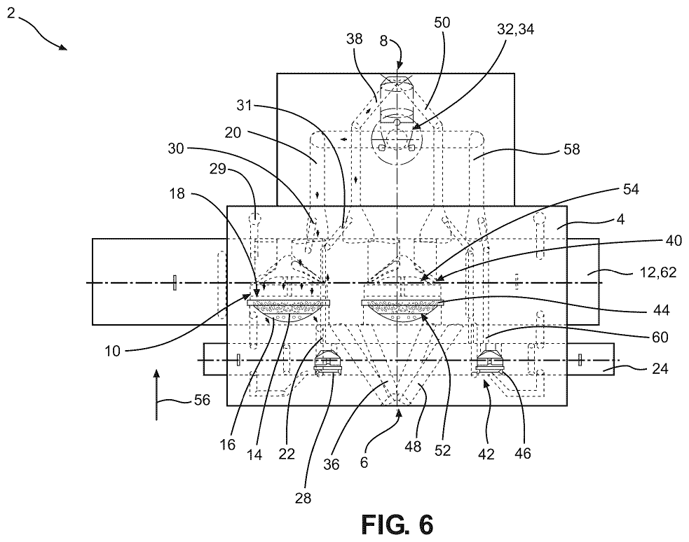

In the state shown in FIG. 6, melt is fed to the screen chamber 10 and thus to the filter element 14 by means of the displacement plunger 34 starting from the clean side 18 via the backflush discharge channel 20. This backflushes the filter element 14, i.e., contaminants that have accumulated on the filter side 16 of the filter element 14 are detached from the filter element 14. The mixture of plastic and contaminants detached from the filter element 14 then passes by means of the backflush discharge channel 22 to the backflush filter element 28, in particular to the filter side 25 of the backflush filter element 28. The backflushed melt is now filtered by means of the backflush filter element 28 and passes from there via the second backflush discharge channel 31 to the discharge channel 38, which in turn opens into the outlet 8. In other words, the plastic used for backflushing is fed back into the process after filtering by means of the backflush filter element 28. The second filter element 44 remains connected to the inlet 6 via the feed channels 36, 48 and is available for filtration.

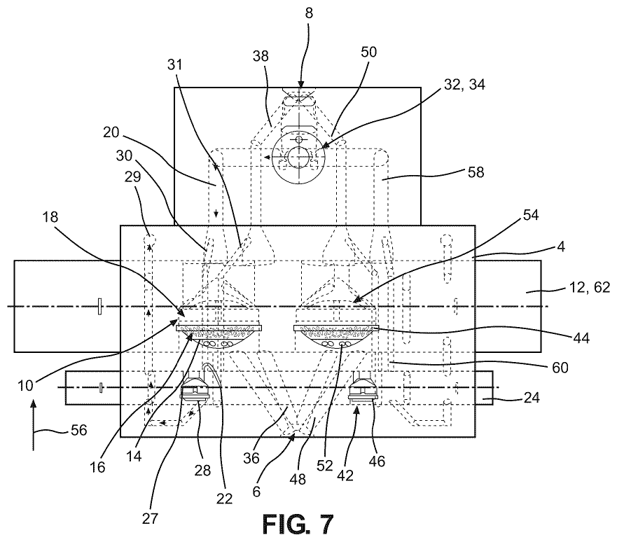

In FIG. 7, backwashing of the backwash filter element 28 takes place. Again, by means of the displacement plunger 34, pressurized plastic melt is fed to the backwash feed channel 20, which reaches the backwash filter element 28, in particular 5 the clean side 27 of the backwash filter element 28, via the second backwash feed channel 30. By means of the plastic, contaminants are detached from the filter side 25 of the backflush filter element 28 and then the highly contaminated plastic/contaminant mixture is pressed in the direction of the discharge outlet 29 and discharged there.

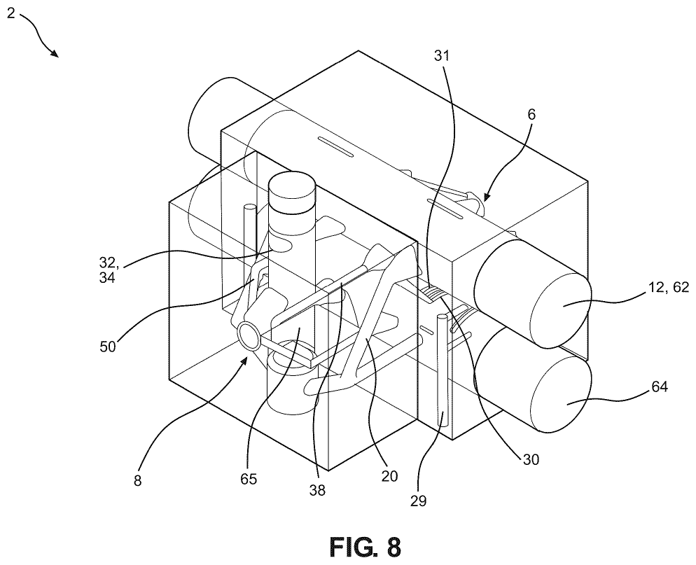

FIGS. 8 to 18 detail the individual process steps that are carried out to flush the filter element 14 via the backflush filter element 28. In the condition shown in FIG. 8, the displacement plunger 34 is first retracted to remove plastic melt from the production process. This collects in a reservoir 65 forming in the displacement plunger 34. The screen carriers 12 or 62 and 64 are in the production position already described with reference to FIG. 5.

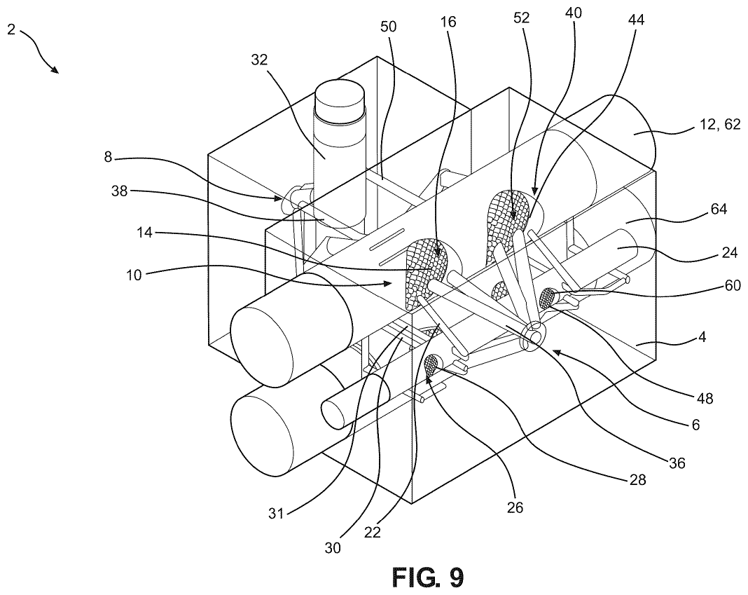

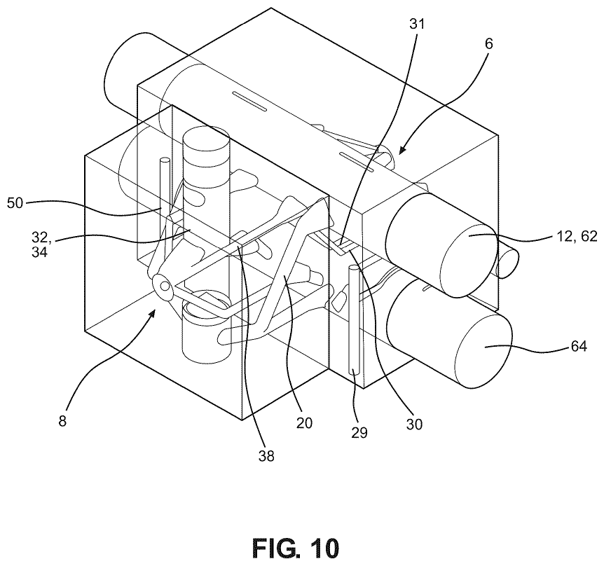

In FIG. 9, the backflush screen support 24 has been moved to a so-called locked position. The sieve compartments 26 and 42 of the backflush sieve carrier 24 are separated from the inlet 6 and the outlet 8. In the state shown in FIG. 10, the second screen carrier 64 has been moved into a so-called backwash release position in such a way that the lower filter elements arranged in the second screen carrier 64 are separated from the respective backwash feed channels 20 and thus there is no longer any direct connection to the displacer plunger 34. The second screen carrier 64 remains in production via the discharge channels 38.

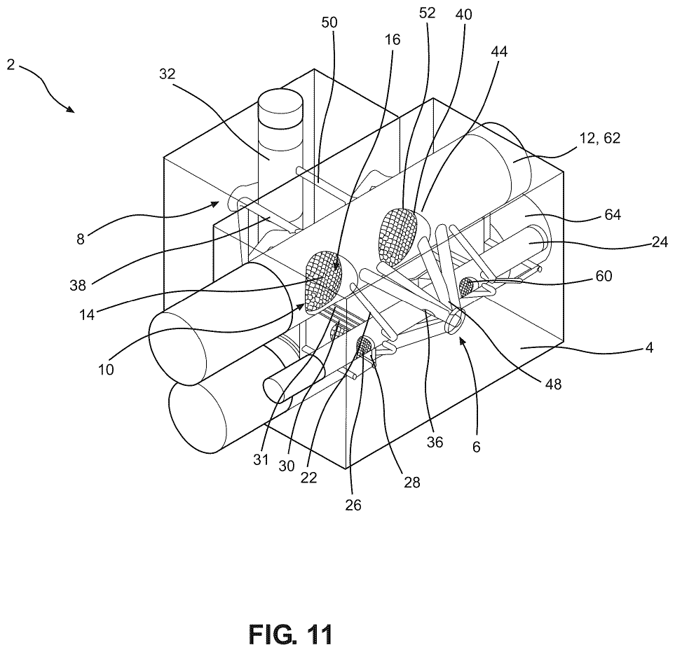

In the condition shown in FIG. 11, the first screen support 62 has been moved to a so-called compression position. In this position, the second filter element 44 is separated from the channel leading to the displacement plunger 34. However, the second filter element 44 is still connected to the outlet 8 via the second discharge channel 50, so that plastic melt can be filtered via the second filter element 44. The filter element 14 is separated from the feed channel 36 and the discharge channel 38. The filter element 14 is only still connected to the displacement plunger 34 via the backflush feed channel 20.

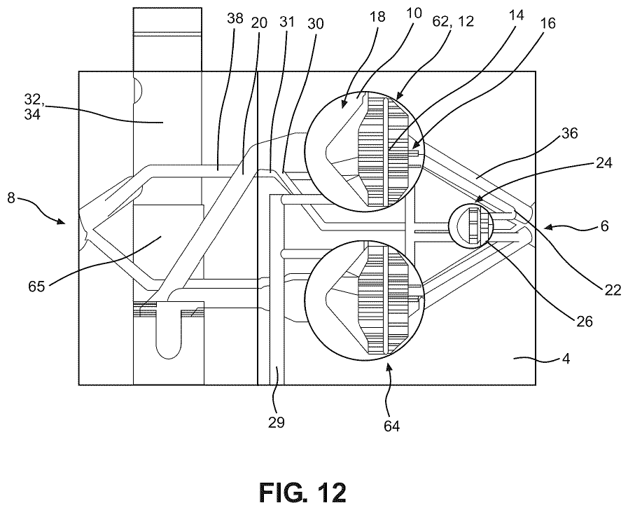

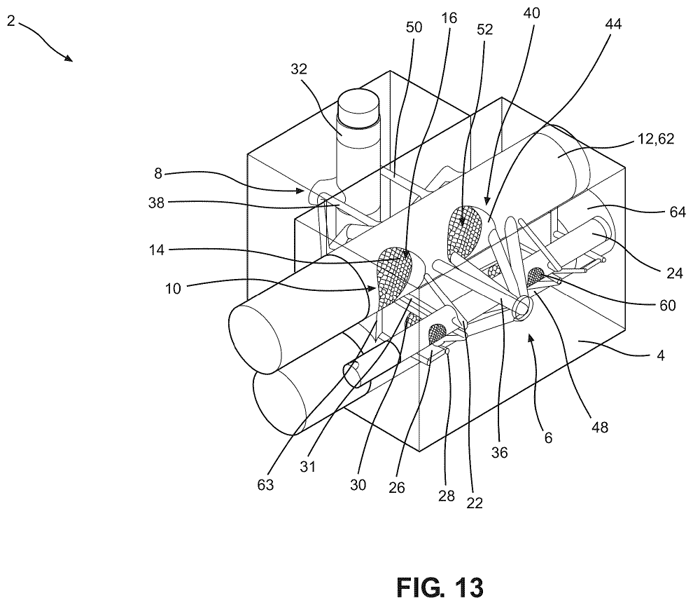

In the condition shown in FIG. 12, the displacement plunger 34 has been pressed down. This pressurizes the melt in the reservoir 65 and also the melt in the backflush feed channel 20 and in the screen chamber 10. In the condition shown in FIG. 13, the screen support 12 is moved so that the screen chamber 10 and the filter element 14 briefly assume a connection with a backflush channel 63 that is temporarily open to the atmosphere. The pressurized compressed melt quickly relaxes and dislodges debris from the filter element 14. The second filter element 44 remains in production.

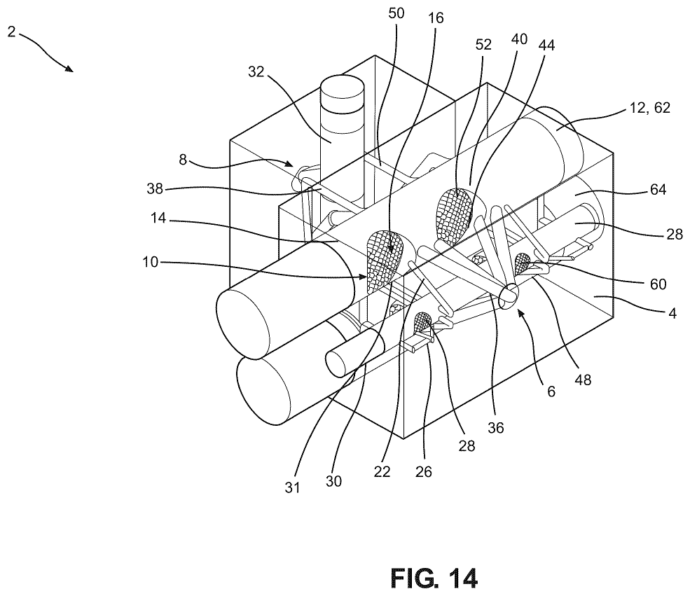

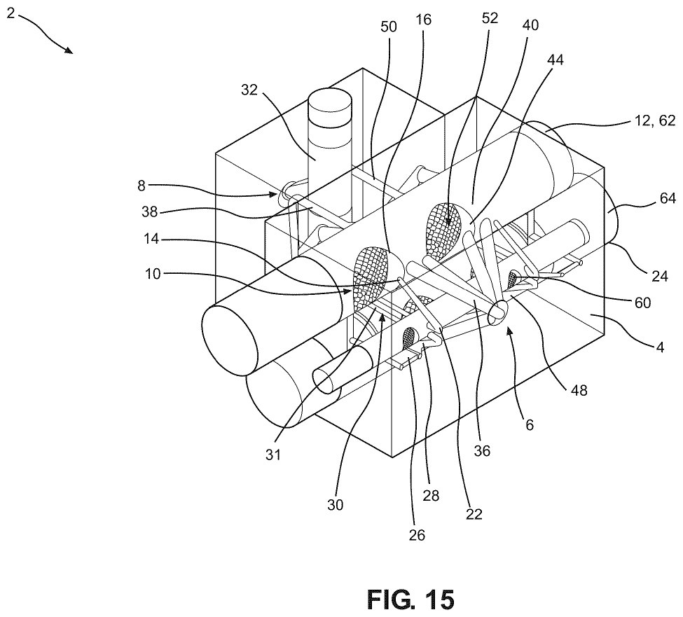

In the state shown in FIG. 14, the screen carrier 12 was moved slightly to the right. The state shown here corresponds to the compression position from FIG. 11. In FIG. 15, the second screen carrier 64 has been moved to a so-called backflush release position. The filter elements of the second screen support 64 remain in the production position.

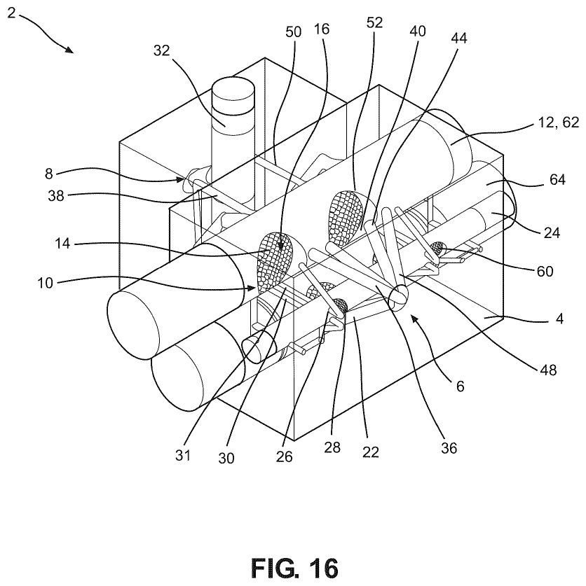

In the state shown in FIG. 16, the backwash screen carrier 24 has been moved so that there is now a connection between the backwash discharge channel 22, the filter element 14 and the backwash filter element 28. On the outlet side, the backwash sieve support 24 is directly connected to the outlet 8.

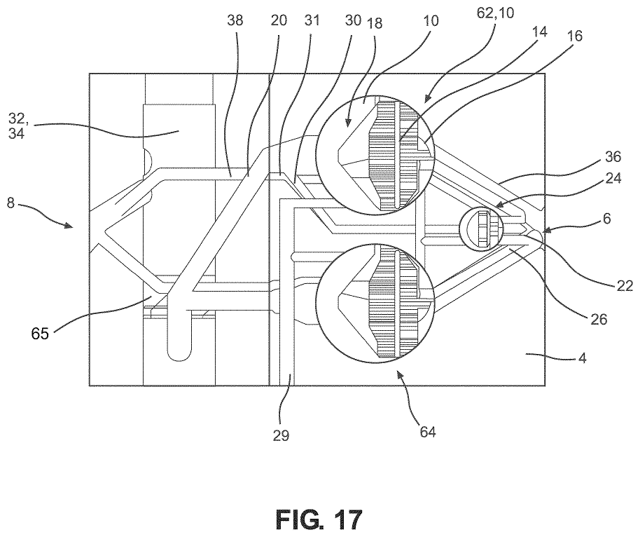

In the state shown in FIG. 17, the displacement plunger 34 is moved downward, as a result of which the plastic melt located in the reservoir 65 is forced from behind first through the filter element 14 and then the backflush filter element 28. The melt filtered by means of the backflush filter element 28 is fed to the outlet 8 and thus to the production process. The dirt from filter element 14 is now in front of backflush filter element 28.

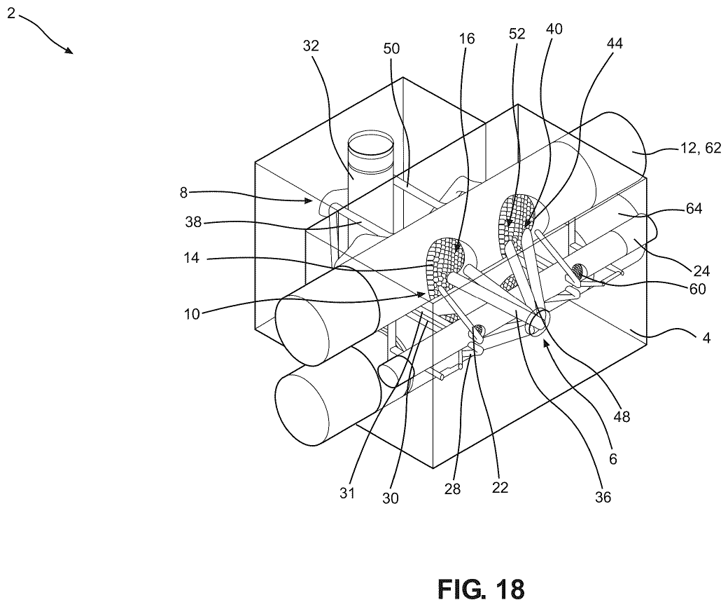

In the condition shown in FIG. 18, both the screen support 12 or 62 and the second screen support 64 and the backflush screen support 24 have been moved back to the production position, so that all six filter elements filter plastic melt fed to the inlet 6 in the direction of the outlet 8.

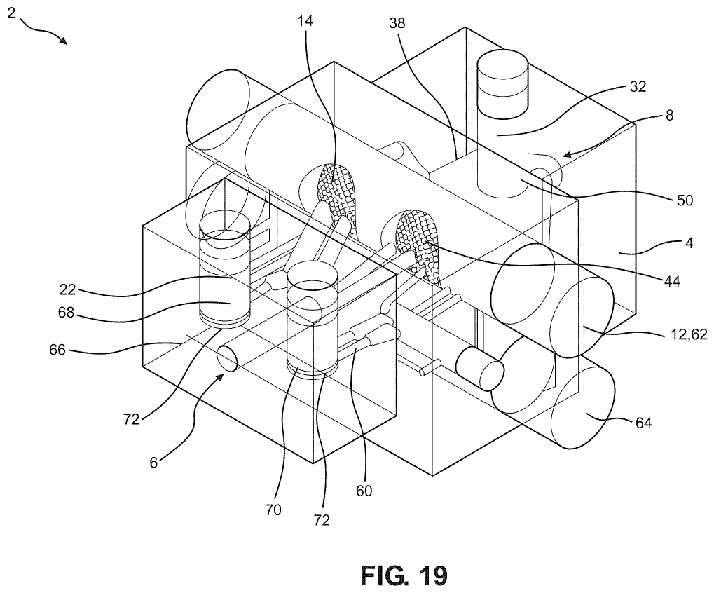

FIG. 19 shows an alternative embodiment of a filtering device 2, which is essentially identical in construction to the embodiment of a filtering device 2 according to FIGS. 1 to 18, but additionally has a storage device 66. The storage device 66 has a first storage plunger 68 and a second storage plunger 70. An annular channel 72 is formed in the lower region of each of the storage plungers 68, 70.

The first storage plunger 68 is connected to the backwash discharge channel 22 and forms a part of the backwash discharge channel 22 with the annular channel 72. The second storage plunger 70 is connected to the backwash discharge channel 60 of the second filter element 44. In an analogous manner, the storage plungers 68, 70 are also connected to the filter elements of the second screen support 64, although only the first screen support 12 is referred to for clarity. The storage device 66 further comprises a channel which opens into the inlet 6.

When the accumulator plungers 68, 70 are in the condition shown in FIG. 19, circulation of melt via the backflush discharge channel 22 and the backflush discharge channel 60 of the second filter element 44 via the respective annular channel 72 is enabled. In FIG. 19, the filtration device 2 is in the production position. Plastic supplied to the inlet 6 flows through all six filter elements. The plastic is filtered through this and passes to the outlet 8, as has already been described with reference to FIGS. 2 and 3.

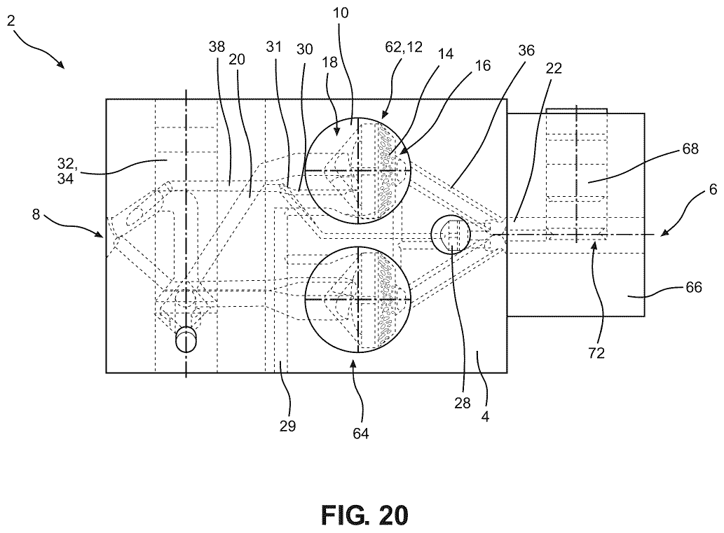

FIG. 20 shows a side view of the filtering device 2 according to the embodiment example in FIG. 19. As can be seen from the figure, the storage plunger 68 is connected to both the first screen support 62 and the second screen support 64 in the manner just described. The melt passes from the filter side 16 of the filter element 14 via the backwash discharge channel 22, which allows permanent circulation through the storage device 66 by means of the annular channel 72, to the backwash filter element 28, is filtered there and fed to the outlet 8.

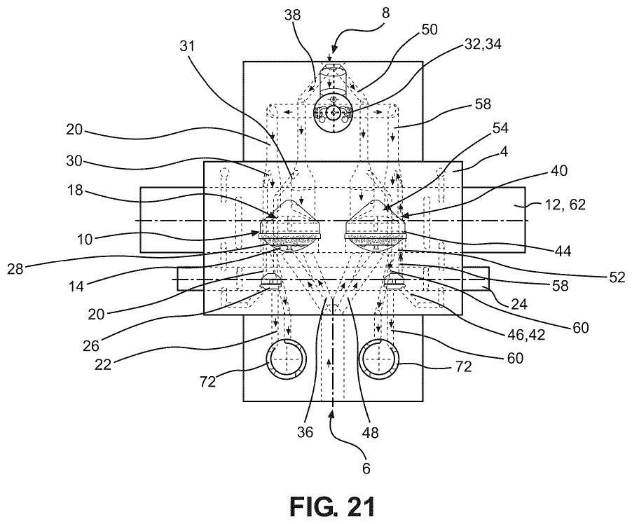

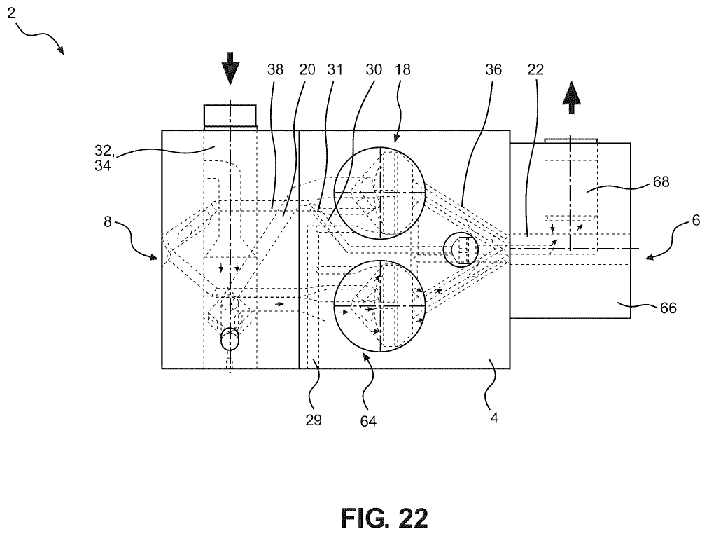

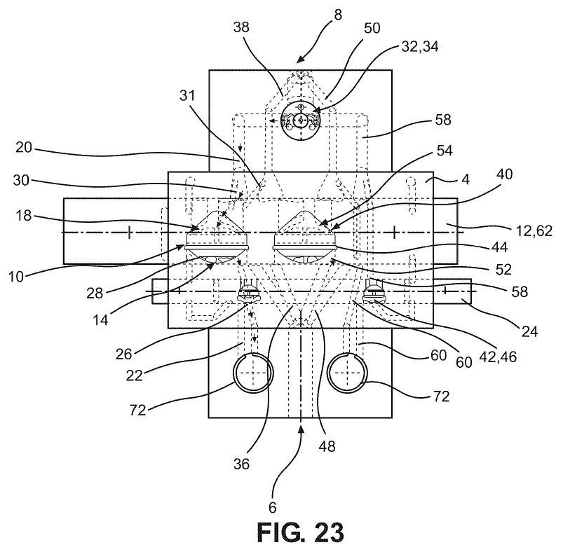

FIG. 21 illustrates the flow of the plastic in the production position by means of arrows using a further illustration. In the state shown in FIG. 22, melt is forced backwards through the filter element of the second screen carrier 64 shown below by means of the displacement plunger 34, reaches the storage device 66, so that the first storage plunger 68 is moved upwards. This condition is shown in FIG. 23 in a top view.

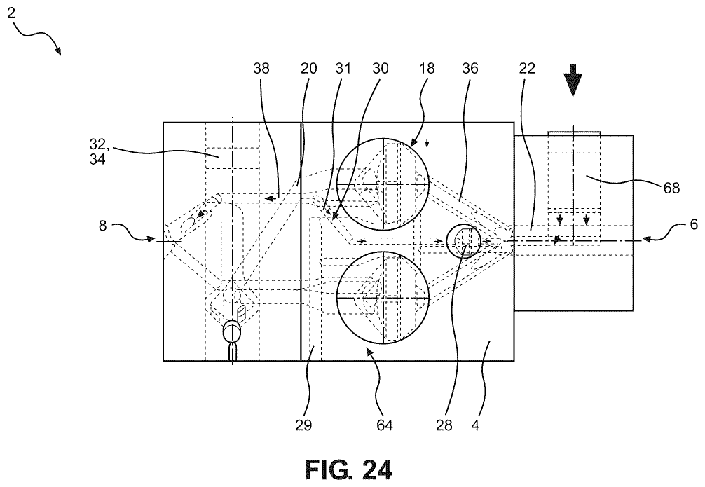

In FIG. 24, the backflushed melt is forced through the backflush filter element 28 by the first accumulator plunger 68 and then discharged toward the outlet 8.

### LIST OF REFERENCE SIGNS

2 Filtration device
4 Housing
6 Admission
8 Outlet
10 Screening room
12 Portafilter
14 Filter element
16 Filter page
18 Inside
20 Backwash feed channel
22 Backwash discharge channel
24 Backflush sieve support
25 Filter side of the backwash filter element
26 Sieve chamber of the backflush sieve support
27 Inside of the backwash filter element
28 Backwash filter element
29 Eject output
30 Second backwash supply channel
31 second backwash discharge channel
32 Pressure generation unit
34 Displacer plunger
36 Feed channel
38 Laxative duct
40 second sieve chamber of the sieve tray
42 Second sieve chamber of the backflush sieve support
44 Second filter element
46 Second backwash filter element
48 second feed channel
50 second laxative channel
52 Filter side of the second filter element
54 Clean side of the second filter element
56 Filtration flow direction
58 Backwash feed channel of the second filter element
60 Backwash discharge channel of the second filter element
61 Channel
62 first portafilter
63 Duct open to atmosphere depending on operating condition
64 second portafilter
65 Reservoir
66 Storage device
68 first memory plunger
70 Second memory plunger
72 Ring channel

1.-18. (canceled)

19. A device for filtering a liquid plastic, comprising:
a housing with an inlet for introducing the plastic and an outlet for discharging the plastic,
a screen carrier accommodated in the housing and having a screen chamber for accommodating a filter element,
a filter element arranged in the screen chamber of the screen carrier and having a filter side and a clean side, wherein the filter element can be brought into communication with the inlet and the outlet in such a way that the plastic passes the filter element in a filtering flow direction from the filter side to the clean side and is filtered, and wherein the filter element can be cleaned by backwashing by plastic flowing counter to the filtering flow direction,
a backwash supply channel fluid-conductively connected to the clean side of the filter element, which is arranged to supply plastic to the filter element against the direction of filtration flow,
a backwash discharge channel fluidly connected to the filter side of the filter element, which is adapted to discharge the backwashed plastic after it has passed through the filter element, and
a backwash screen support fluidly connected to the backwash discharge channel and having a screen chamber for receiving a backwash filter element, and by a backflush filter element arranged in the screen chamber and adapted to filter the backflushed plastic.

20. The device for filtering a liquid plastic according to claim 19,
wherein a second backwash supply channel fluidly connected to the backwash filter element and the outlet, said second backwash supply channel being adapted to supply the plastic filtered by the backwash screen support to the outlet.

21. The device for filtering a liquid plastic according to claim 19, wherein a pressure generating unit which is fluidly connected to the backwash supply channel and/or a second backwash discharge channel, the pressure generating unit being arranged to press plastic for backwashing through the screen carrier and/or the backwash screen carrier against the direction of filtration flow.

22. The device for filtering a liquid plastic according to claim 21,
wherein the housing has a feed channel fluidly connected to the inlet for feeding plastic to the filter side of the filter element and a discharge channel fluidly connected to the outlet for discharging the filtered liquefied plastic from the clean side of the filter element.

23. The device for filtering a liquid plastic according claim 21, wherein the pressure generating unit comprises or is configured as any of the following:
a piston,
a displacement plunger, and/or
a gear pump.

24. The device for filtering a liquid plastic according to claim 21, wherein the pressure generating unit is fluidly connected to the discharge channel and is adapted to remove plastic from the discharge channel and provide it for backflushing.

25. The device for filtering a liquid plastic according to claim 19, wherein the screen chamber of the screen carrier and/or of a backwash screen carrier is a first screen chamber and wherein the screen carrier and/or a backwash screen carrier has a second screen chamber, and wherein a second filter element is arranged in the second screen chamber.

26. The device for filtering a liquid plastic according to claim 25,
wherein
a second feed channel fluidly connected to the inlet for feeding plastic to a filter side of the second filter element,
a second discharge channel fluidly connected to the outlet for discharging the filtered plastic from the clean side of the second filter element,
wherein the second filter element can be brought into communication with the second feed channel and the second discharge channel in such a way that the plastic passes through the second filter element in a filtration flow direction from the filter side to the clean side and is filtered,
a second backwash supply channel of the second filter element, which is fluid-conductively connected to the filter side of the second filter element and is arranged to supply backwash fluid to the second filter element against the direction of filtration flow, and
a second backwash discharge channel fluid-conductively connected to the clean side of the second filter element, which is set up to discharge the backwash fluid after it has passed through the second filter element,
wherein the second backwash discharge channel of the second filter element is fluidly connected to a first backwash filter element or a second backwash filter element of the backwash screen support.

27. The device for filtering a liquid plastic according to claim 19, wherein the screen support is a first screen support and the filtering device comprises a second screen support, and wherein the second screen support is configured like the screen support.

28. The device for filtering a liquid plastic according to claim 19, wherein the filter element of the screen support has substantially the same pore size as the filter element of the backwash screen support.

29. The device for filtering a liquid plastic according to claim 26, wherein a storage device which is connected in a fluid-conducting manner to the backwash discharge channel and/or the second discharge channel and is arranged to store backwash fluid from the backwash discharge channel and/or the second backwash discharge channel.

30. The device for filtering a liquid plastic according to claim 29, wherein the storage device comprises a piston, in particular a storage plunger.

31. A Method for operating a filtering device comprising:
providing a filtering device with a screen support, wherein the screen support comprises at least one filter element arranged in a screen chamber,
filtering a liquefied plastic by means of the filter element in a filtering flow direction,
backwashing of the filter element by means of the filtered plastic against the direction of filtration flow,
directing a backflushed plastic to a backflush filter element after passing through the filter element,
filtering the backflushed plastic by means of the backflush filter element.

32. The method according to claim 31, further comprising merging the filtered backflushed plastic and the filtered liquefied plastic.

33. The method according to claim 31, further comprising:
backflushing the backflush filter element using the filtered liquefied plastic, and
discharge of a contaminated liquefied plastic after backflushing of the backflush filter element.

34. The method according to claim 31, wherein the filtering of the liquefied plastic is performed both by means of the filter element and by means of the backflush filter element.

35. The method according to claim 31, wherein a synthetic material used for backwashing the filter element or the backwashing filter element for triggering the backwashing has a higher pressure than the synthetic material to be filtered, a pressure difference being in particular 10 bar-50 bar.

36. The method according to claim 31, wherein an artificial material used for backwashing is sucked in in the backwashing direction downstream of the filter element and/or the backwashing filter element.
